(19) United States
(12) Patent Application Publication
(10) Pub. No.: US 2026/0211090 A1
(43) Pub. Date: Jul. 23, 2026

(54) STEERABLE GATED IMAGING SYSTEM

(71) Applicant: GM Global Technology Operations LLC, Detroit, MI (US)

(72) Inventor: Tzvi Philipp, Bet Shemesh (IL)

(21) Appl. No.: 19/035,253

(22) Filed: Jan. 23, 2025

(51) Int. Cl. G01S 7/486; G01S 7/481; G01S 17/89; G01S 17/931; G02B 5/18; G02F 1/1335

(52) U.S. Cl. CPC G01S 7/4868; G01S 7/4816; G01S 17/89; G01S 17/931; G02B 5/1842; G02F 1/133528

(57) ABSTRACT

A steerable gated imaging system includes a light source, a camera including a camera sensor, a first liquid crystal polarized grating (LCPG) device, a second LCPG device, and a controller. The light source emits a pulse of light towards an object. The pulse of light creates a reflection of light off of the object. The camera captures an image when the camera sensor senses the reflection of light. The first LCPG device is adjacent to the light source. The pulse of light is emitted through the first LCPG device. The second LCPG device is adjacent to the camera. The reflection of light travels through the second LCPG device. The controller applies a voltage to the first LCPG device to steer the light pulse towards the object. The controller applies the voltage to the second LCPG device to steer the reflection of light towards the camera.

### INTRODUCTION

The present disclosure relates to a steerable gated imaging system. More particularly, the present disclosure relates to a steerable gated imaging system in a vehicle to capture images of a scene external to the vehicle.

A gated imaging system includes a light source that sends out a pulse of light. The gated imaging system also includes a gate and a camera that captures an image illuminated by the pulse of light when the gate is open during a pre-determined time gate. When the gate is open, the camera senses a reflection from the pulse of light and captures the image of the scene. The time gate controls when the camera captures the reflection of light within a field of view (FOV). The FOV is limited due to the number of sample pixels the gated imaging system can support.

Thus, to increase the FOV of the images captured, there is a need for a new and improved gated imaging system.

### SUMMARY

According to several aspects, a steerable gated imaging system for capturing images of an object is provided. The steerable gated imaging system includes a light source. The light source emits a pulse of light towards the object. The pulse of light creates a reflection of light off of the object. The steerable gated imaging system further includes a camera including a camera sensor. The camera captures an image when the camera sensor senses the reflection of light. The steerable gated imaging system further includes a first liquid crystal polarized grating (LCPG) device. The first LCPG device is connected to the light source. The pulse of light is emitted through the first LCPG device. The steerable gated imaging system further includes a second LCPG device. The second LCPG device is connected to the camera. The reflection of light travels through the second LCPG device. The steerable gated imaging system further includes a controller. The controller applies a voltage to the first LCPG device to steer the light pulse towards the object. The controller applies the voltage to the second LCPG device to steer the reflection of light towards the camera.

In an additional aspect of the present disclosure, the controller is configured to control a pre-determined time interval. The pulse of light is emitted during the pre-determined time interval.

In another aspect of the present disclosure, the steerable gated imaging system further comprises a gate. The gate has a position. The position includes a closed position and an open position.

In another aspect of the present disclosure, the controller is configured to control the position of the gate.

In another aspect of the present disclosure, the closed position of the gate prevents the reflection of light from reaching the camera sensor.

In another aspect of the present disclosure, the controller is configured to control a delay period. The delay period is a period of time after the pulse of light has been emitted. The gate is in the closed position during the delay period.

In another aspect of the present disclosure, the open position of the gate allows the reflection of light to reach the camera sensor.

In another aspect of the present disclosure, the controller is configured to control a time gate. The time gate is a period of time in which the controller maintains the gate in the open position.

In another aspect of the present disclosure, the controller incrementally adjusts the voltage applied to the first LCPG device and the second LCPG device in a sequential order. The camera captures images at each incremental adjustment in the voltage.

In another aspect of the present disclosure, the controller further comprises a processor. The processor combines the images captured.

In another aspect of the present disclosure, the controller incrementally adjusts the voltage applied to the first LCPG device and the second LCPG device in a non-sequential order. The camera captures images at each incremental adjustment in the voltage

In another aspect of the present disclosure, the controller further comprises a processor, wherein the processor combines the images captured.

According to several aspects, a steerable gated imaging system for a vehicle is provided. The vehicle has a controller that controls a voltage applied to the steerable gated imaging system. The steerable gated imaging system includes a light source. The light source emits a pulse of light during a pre-determined time interval towards an object external to the vehicle. The pulse of light creates a reflection of light off of the object. The steerable gated imaging system further includes a camera including a camera sensor. The camera captures an image when the camera sensor senses the reflection of light. The gated steerable imaging system further includes a first liquid crystal polarized grating (LCPG) device. The first LCPG device is adjacent to the light source. The pulse of light is emitted through the first LCPG device. The steerable gated imaging system further includes a second LCPG device. The second LCPG device is adjacent to the camera. The reflection of light travels through the second LCPG device. The steerable gated imaging system further includes a gate. The gate is has a position. The position of the gate includes a closed position. The closed position prevents the reflection of light from reaching the camera sensor. The position of the gate further includes an open position. The open position allows the reflection of light to reach the camera sensor. The voltage is applied to the first LCPG device to steer the pulse of light towards the object. The voltage is applied to the second LCPG device to steer the reflection of light towards the camera. The voltage is incrementally adjusted in a sequential order.

In another aspect of the present disclosure, the steerable gated imaging system further includes a delay period. The delay period is a period of time after the pulse of light has been emitted. The gate is in the closed position during the delay period.

In another aspect of the present disclosure, the steerable gated imaging system further includes a time gate. The time gate is a period of time that the gate is in the open position.

In another aspect of the present disclosure, the camera further comprises capturing images at each incremental adjustment of the voltage. The images are combined to create a final image.

According to several aspects, a steerable gated imaging system for a vehicle is provided. The vehicle has a controller that controls a voltage applied to the steerable gated imaging system. The steerable gated imaging system includes a light source. The light source emits a pulse of light during a pre-determined time interval towards an object external to the vehicle. The pulse of light creates a reflection of light off of the object. The steerable gated imaging system further includes a camera including a camera sensor. The camera captures an image when the camera sensor senses the reflection of light. The steerable gated imaging system further includes a first liquid crystal polarized grating (LCPG) device. The first LCPG device is adjacent to the light source. The pulse of light is emitted through the first LCPG device. The steerable gated imaging system further includes a second LCPG device. The second LCPG device is adjacent to the camera. The reflection of light travels through the second LCPG device. The steerable gated imaging system further includes a gate. The gate is has a position. The position includes a closed position. The closed position prevents the reflection of light from reaching the camera sensor. The position further includes an open position. The open position allows the reflection of light to reach the camera sensor. The voltage is applied to the first LCPG device to steer the pulse of light towards the object. The voltage is applied to the second LCPG device to steer the reflection of light towards the camera. The voltage is incrementally adjusted in a non-sequential order.

In another aspect of the present disclosure, the steerable gated imaging system further includes a delay period. The delay period is a period of time after the pulse of light has been emitted. The gate is in the closed position during the delay period.

In another aspect of the present disclosure, the steerable gated imaging system further includes a time gate. The time gate is a period of time that the gate is in the open position.

In another aspect of the present disclosure, the camera further includes capturing images at each incremental adjustment in the voltage. The images are combined to create a final image.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic drawing for a steerable gated imaging system according to an exemplary embodiment.

FIG. 2 is an enlarged cross-section view of a first liquid crystal polarization grating (LCPG) device according to an exemplary embodiment.

FIG. 3A is a schematic view for the steerable gated imaging system with a gate in a closed position according to an exemplary embodiment.

FIG. 3B is a schematic view for the steerable gated imaging system with the gate in an open position according to an exemplary embodiment.

FIG. 4A is a schematic view for a steerable gated imaging system with the first LCPG device and a second LCPG device according to an exemplary embodiment.

FIG. 4B is another schematic view for a steerable gated imaging system with the first LCPG device and the second LCPG device according to an exemplary embodiment.

### DETAILED DESCRIPTION

The following description is merely exemplary in nature and is not intended to limit the present disclosure, application, or uses.

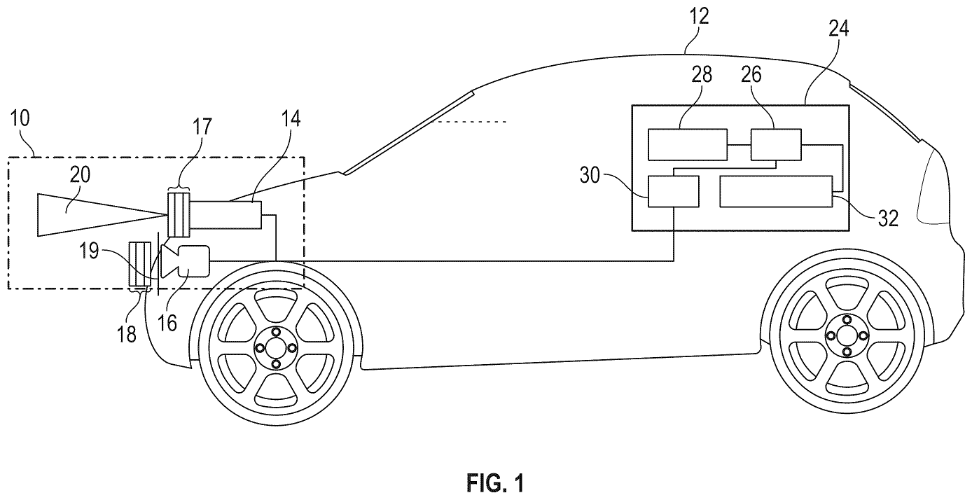

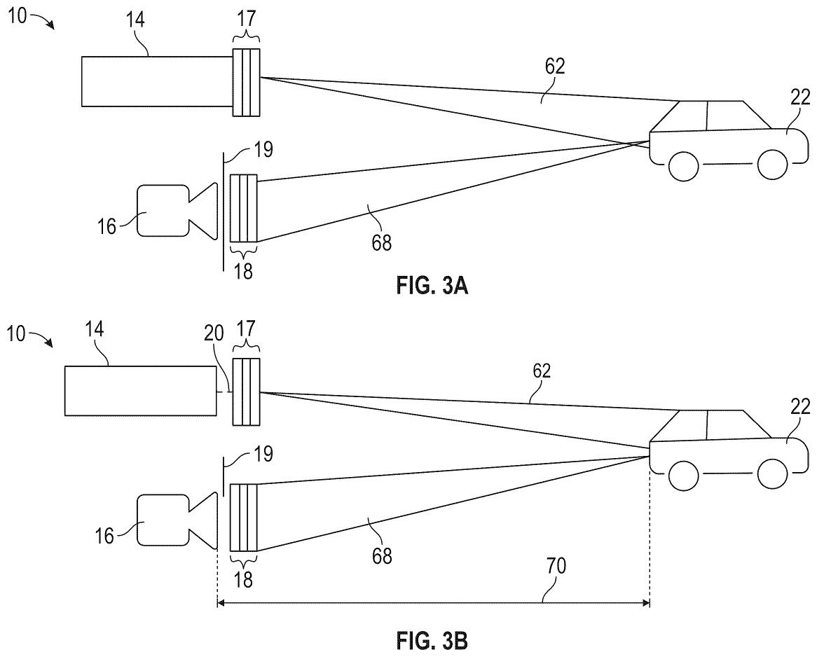

Referring to FIG. 1, a steerable gated imaging system 10 for capturing images of a scene external to a vehicle 12 is illustrated. The steerable gated imaging system 10 includes a light source 14, a camera 16, a first liquid crystal polarization grating (LCPG) device 17, a second LCPG device 18 and a gate 19. The light source 14 emits a pulse of light 20 during pre-determined time intervals, illuminating a field of view (FOV). The light source 14 is a polarized light with a linear polarization such as, but not limited to, a laser. The camera 16 captures an image of an object 22 (shown in FIGS. 3A-3B) external to the vehicle 12. The camera 16 includes a camera sensor (not shown) disposed within the camera 16. The camera sensor senses the pulse of light 20 from the light source 14 and captures the image when the gate 19 is open. The gate 19 is programmed to open and close during a pre-determined time gate. The gate 19 and the time gate are described in further detail below. The first LCPG device 17 is adjacent to the light source 14 and the second LCPG device 18 is adjacent to the camera 16. The first LCPG device 17 and the second LCPG device 18 are described in further detail below.

The steerable gated imaging system 10 communicates with a controller 24. The controller 24 in the vehicle 12 includes a voltage driver to apply a voltage to the first LCPG device 17 and to the second LCPG device 18, operating the first LCPG device 17 and the second LCPG device 18 in a synchronous manner. The applied voltage steers the light source 14 and the camera 16 to the same angle. The controller also controls the time intervals for the light source 14, controls the time gate, and controls a period delay. The controller 24 is a non-generalized electronic control device having a preprogrammed digital computer or processor 26, a memory 28, an input and output ports 30, and the transceiver 32.

The processor 26 can be a custom made or a commercially available processor, a central processing unit (CPU), a graphics processing unit (GPU), an auxiliary processor among several processors associated with the controller 24, a semiconductor-based microprocessor (in the form of a microchip or chip set), a macroprocessor, a combination thereof, or generally a device for executing instructions. The memory 28 is used to store data such as control logic, software applications, instructions, computer code, data, lookup tables, etc. The memory 28 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. The processor 26 is configured to execute the code or instructions.

The input and output ports 30 are wired to the camera 16 to receive incoming data from the camera sensor disposed in the camera 16. The transceiver 32 is configured to communicate the incoming data received by the input and output ports 30 from the camera 16 to the processor 26. The input and output ports 30 also receive outgoing data from the processor 26. The transceiver 32 is configured to wirelessly communicate the outgoing data received by the input and output ports 30 to the camera 16.

It is to be appreciated that FIG. 1 is merely exemplary in nature, and the steerable gated imaging system 10 is not limited to being employed as an imaging system for the vehicle 12. Indeed, steerable gated imaging system 10 may be used in a variety of other electromobility and stationary applications. It is also to be appreciated that although the vehicle 12 is illustrated as a sedan, the vehicle 12 may be any type of vehicle such as, but not limited to, a truck, sport utility vehicle, van, or motor home.

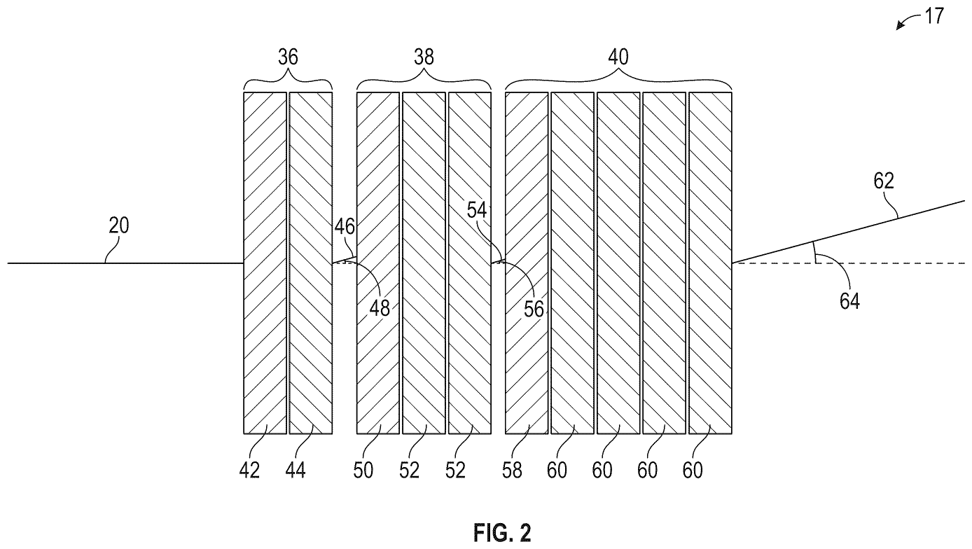

Referring to FIG. 2, an enlarged cross-section view of the first LCPG device 17 is illustrated. It should be appreciated that the first LCPG device 17 and the second LCPG device 18 are identical, and therefore only the first LCPG device 17 will be described herein. The first LCPG device 17 is adjacent to the light source 14 (shown in FIG. 1) of the steerable gated imaging system 10. The first LCPG device 17 diffracts the pulse of light 20. The first LCPG device 17 may include, but is not limited to, a first stage 36, a second stage 38, and a third stage 40. Alternatively, the first LCPG device 17 may include, at a minimum, the first stage 36 or the first LCPG device 17 may include, at a maximum, a number of stages limited by light transmission efficiency.

The first stage 36 includes a first liquid crystal phase plate 42 and a first polarized grating 44. The first liquid crystal phase plate 42 is composed of liquid crystals. When the pulse of light 20 passes through the first liquid crystal phase plate 42, the first liquid crystal phase plate 42 creates a phase delay and alters an orientation of the pulse of light 20, creating a first output of light 46. A quarter wave of phase delay is introduced to the pulse of light 20. The pulse of light 20 has a linear polarization, causing the quarter wave of phase delay to create a 90° phase shift to the first output of light 46. Additionally, the controller 24 (shown in FIG. 1) is programmed to apply a voltage to the first liquid crystal phase plate 42. The voltage alters the orientation first liquid crystal phase plate 42 and creates a specific orientation of the liquid crystals. The application of the voltage affects the polarization of the first output of light 46. For example, when the pulse of light 20, which is linearly polarized, passes through the first liquid crystal phase plate 42, the first output of light 46 translates to a circular polarization. The voltage applied also determines the direction of polarization. For example, when a first voltage is applied to the first liquid crystal phase plate 42, the first output of light 46 may have a circular left polarization. Alternatively, when a second voltage is applied to the first liquid crystal phase plate 42, the first output of light 46 may have a circular right polarization.

The first polarized grating 44 diffracts and steers the first output of light 46 based on the polarization of the light source 14. Therefore, when the pulse of light 20 passes through the first polarized grating 44 the pulse of light 20 steers the first output of light 46 by diffracting the pulse of light 20 at a first output angle 48. For example, if the first output of light 46 has a right circular polarization after passing through the first liquid crystal phase plate 42, the first polarized grating 44 diffracts the first output of light 46 at the first output angle 48 to the right. Alternatively, if the first output of light 46 has a left circular polarization after passing through the first liquid crystal phase 36, the first polarized grating 44 diffracts the first output of light 46 at the first output angle 48 angle to the left.

The second stage 38 includes a second liquid crystal phase plate 50 and a second polarized grating 52. The second liquid crystal phase plate 50 is composed of liquid crystals. The controller 24 (shown in FIG. 1) applies a voltage to alter the orientation and create a specific orientation of the liquid crystals, creating a phase delay. The first output of light 46 passes through the second liquid crystal phase plate 50, creating a second output of light 54. The second liquid crystal phase plate 50 introduces a half wave of phase delay to the second output of light 54. The half wave phase delay creates a 180° phase shift to the second output of light 54. For example, when the first output of light 46 passes through the second liquid crystal phase plate 50, the second output of light 52 will be rotated 90°, switching the polarization between left circular polarization and right circular polarization.

The second polarized grating 52 diffracts and steers the second output of light 54 based on the polarization of the light source 14 (shown in FIG. 1). The second polarized grating 52 includes two polarized gratings that are holographically embossed smooth surfaces with a phase pattern deposited on the surface. Therefore, when the first output of light 46 passes through the second polarized grating 52, the first output of light 46 is diffracted at a second output angle 56, creating the second output of light 54. The second output angle 56 is defined by adding the first output angle 48 and the diffraction created by passing through the second polarized grating 52.

The third stage 40 includes a third liquid crystal phase plate 58 and a third polarized grating 60. The third liquid crystal phase plate 58 is composed of liquid crystals. The controller 24 (shown in FIG. 1) applies a voltage to alter the orientation and create a specific orientation of the liquid crystals, creating a phase delay. The second output of light 54 passes through the third liquid crystal phase plate 58, creating a final output of light 62. The third liquid crystal phase plate 58 introduces a half wave of phase delay to the final output of light 62. The half wave phase delay creates a 180° phase shift to the final output of light 62. For example, when the second output of light 54 passes through the third liquid crystal phase plate 58 at a 45° angle, the first output of light 46 will be rotated 90°.

The third polarized grating 60 diffracts and steers the final output of light 62 based on the polarization of the light source 14 (shown in FIG. 1). The third polarized grating 60 includes four polarized gratings that are holographically embossed smooth surfaces with a phase pattern deposited on the surface. Therefore, when the second output of light 54 passes through the third polarized grating 60, the second output of light 54 is diffracted at a final output angle 64 creating the final output of light 62. The final output angle 64 is defined by adding the first output angle 48, the second output angle 56, and the diffraction created by passing through the third polarized grating 60.

Referring to FIG. 3A, a schematic view of the steerable gated imaging system 10 with the gate 19 in a closed position is illustrated. The gate 19 has a position, which includes the closed position and an open position. When the gate 19 is in the closed position, the gate 19 prevents the camera sensor from sensing the reflection of light 68. The camera 16 is programmed to capture the image of the object 22 when the camera sensor senses the reflection of light 68. Therefore, while the gate 19 is in the closed position, the camera 16 does not capture the image of the object 22.

Referring to FIG. 3B, a schematic view of the steerable gated imaging system 10 with the gate 19 in the opened position is illustrated. The pulse of light 20 travels through the first LCPG device 17 creating the final output of light 62. The final output of light 62 illuminates the field of view (FOV) and when the final output of light 62 reaches the object 22, the reflection of light 68 is created. The reflection of light 68 travels through the second LCPG device 18 towards the camera 16. While the gate 19 is in the open position, the camera sensor senses the reflection of light 68. The camera 16 is programmed to capture the image of the object 22 when the camera sensor senses the reflection of light 68. Therefore, the camera 16 captures the image of the object 22 when the gate 19 is in the open position. The object 22 may be, but is not limited to, a vehicle, a pedestrian, a traffic light, and/or a traffic sign.

The controller 24 (shown in FIG. 1) opens the gate 19 after a delay period. The delay period is a period of time after the light source 14 emits the pulse of light 20 where the gate 19 remains in the closed position. After the delay period has lapsed, the gate 19 moves to the open position. The delay period defines a distance 70 in which the final output of light 62 may travel. Altering the delay period changes the distance 70 of the object 22 captured by the camera 16. For example, a short delay period would cause the gate 19 to open sooner, causing the camera 16 to capture images of the object 22 that are a shorter distance 70 from the steerable gated imaging system 10. Alternatively, a long delay period would cause the gate 19 to open later, causing the camera 16 to capture images of the object 22 that are a greater distance 70 from the steerable gated imaging system 10.

The gate 19 remains in the open position during a time gate. The time gate is a period of time in which the controller 24 (shown in FIG. 1) maintains the gate 19 in the open position. The gate 19 returns to the closed position after the time gate has lapsed. The distance 70 is further defined by the time gate. For example, if the time gate is long, the gate 19 stays open for a longer period of time. This allows the reflection of light 68 from the object 22 to travel a greater distance 70 from the object 22 to the steerable gated imaging system 10. Alternatively, if the time gate is short, the gate 19 stays open for a shorter period of time. This causes the camera sensor to only sense the reflection of light 68 from the object 22 that is a closer distance 70 from the steerable gated imaging system 10.

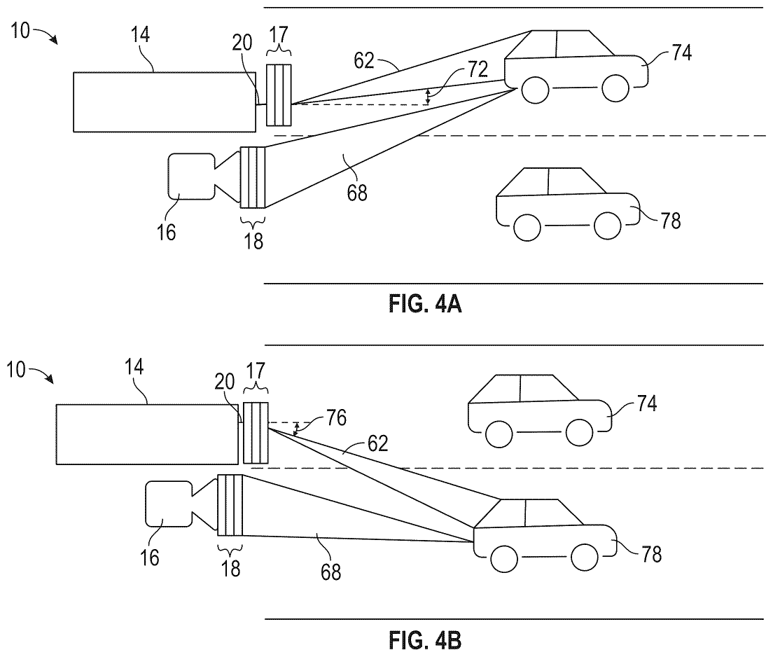

Referring to FIG. 4A and FIG. 4B, a schematic view for a steerable gated imaging system 10 with the first LCPG device 17 and the second LCPG device 18 is illustrated. The light source 14 emits a pulse of light 20 through the first LCPG device 17. The first LCPG device 17 steers the pulse of light 20 by diffracting the final output of light 62. The final output of light 62 creates the reflection of light 68, which travels through the second LCPG device 18. The controller 24 (shown in FIG. 1) applies the voltage to the first LCPG device 17 and to the second LCPG device 18, altering the orientation of the liquid crystals. The voltage also affects the polarization of the pulse of light 20 passing through the first LCPG device 17 and affects the polarization of the reflection of light 68 passing through the second LCPG device 18. The change in the polarization and the alteration of the orientation of the liquid crystals causes the final output of light 62 and the reflection of light 68 to diffract.

The diffraction of the final output of light 62 and the diffraction of the reflection of light 68 may be dictated by applying varying voltages to the first LCPG device 17 and to the second LCPG device 18. As shown in FIG. 4A, a first voltage has been applied to the first LCPG device 17 and the second LCPG device 18. The first voltage applied to the first LCPG device 17 causes the final output of light 62 to be diffracted at a first angle 72 towards a first object 74. The first voltage applied to the second LCPG device 18 allows the camera 16 to capture an image of the first object 74. Alternatively, in FIG. 4B, a second voltage, which is different than the first voltage, has been applied to the first LCPG device 17 and to the second LCPG device 18. The second voltage applied to the first LCPG device 17 causes the final output of light 62 to be diffracted at a second angle 76 towards a second object 78. The second voltage applied to the second LCPG device 18 allows the camera 16 to capture an image of the second object 78. The second object 78 is positioned at a different point in the external scene than the first object 74. After the camera 16 captures the images for both the first object 74 and the second object 78, the processor 26 (shown in FIG. 1) may combine the two images to create a final image. The FOV of each individual image captured remains the same, but combining the two images increases the FOV. Additionally, combining the images increases the FOV while maintaining a high resolution in the images captured.

The controller 24 (shown in FIG. 1) may be programmed to alter the voltage of the first LCPG device 17 multiple times, causing the final output of light 62 to diffract in different angles. The controller 24 may be programmed to synchronize the voltage applied to the first LCPG device 17 and the second LCPG device 18. The camera 16 captures multiple images with different angles of the scene. The controller may be programmed to adjust the voltage incrementally in a sequential order. By causing the diffraction to be sequential, the images captured by the camera 16 will also be sequential. The processor 26 (shown in FIG. 1) combines the images captured, creating a final image.

Alternatively, the controller 24 (shown in FIG. 1) may be programmed to adjust the voltage incrementally in non-sequential order. This causes the diffraction of the final output of light 62 and the reflection of light 68 captured by the camera 16 to be non-sequential. The controller 24 (shown in FIG. 1) may be programmed to detect a bare area of the scene or an area where no image is needed or wanted. By detecting this, the voltage applied to the first LCPG device 17 and the second LCPG device 18 will be non-sequential and skip an unwanted voltage value. Therefore, when the processor 26 (shown in FIG. 1) combines the multiple images captured, a portion of the scene will be omitted from the final image. Even though the final image omits a portion of the scene, the FOV is still increased due to the additional images captured and combined.

A steerable gated imaging system 10 of the present disclosure offers several advantages. These include increasing the FOV of the final image by altering the voltage applied in a sequential or nonsequential order and combining the images at each voltage applied. Additionally, the high resolution of the final image is maintained by capturing multiple images with a smaller FOV.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A steerable gated imaging system for capturing images of an object, the steerable gated imaging system comprising:
a light source, wherein the light source emits a pulse of light towards the object and wherein the pulse of light creates a reflection of light off of the object;
a camera including a camera sensor, wherein the camera captures an image when the camera sensor senses the reflection of light;
a first liquid crystal polarized grating (LCPG) device, wherein the first LCPG device is adjacent to the light source and wherein the pulse of light is emitted through the first LCPG device;
a second LCPG device, wherein the second LCPG device is adjacent to the camera and wherein the reflection of light travels through the second LCPG device; and
a controller, wherein the controller applies a voltage to the first LCPG device to steer the pulse of light towards the object and wherein the controller applies the voltage to the second LCPG device to steer the reflection of light towards the camera.

2. The steerable gated imaging system of claim 1, wherein the controller is configured to control a pre-determined time interval and wherein the pulse of light is emitted during the pre-determined time interval.

3. The steerable gated imaging system of claim 1, wherein the steerable gated imaging system further comprises a gate, wherein the gate has a position, the position includes a closed position and an open position.

4. The steerable gated imaging system of claim 3, wherein the controller is configured to control the position of the gate.

5. The steerable gated imaging system of claim 4, wherein the closed position of the gate prevents the reflection of light from reaching the camera sensor.

6. The steerable gated imaging system of claim 5, wherein the controller is configured to control a delay period, wherein the delay period is a period of time after the pulse of light has been emitted, and wherein the gate is in the closed position during the delay period.

7. The steerable gated imaging system of claim 4, wherein the open position of the gate allows the reflection of light to reach the camera sensor.

8. The steerable gated imaging system of claim 7, wherein the controller is configured to control a time gate, wherein the time gate is a period of time in which the controller maintains the gate in the open position.

9. The steerable gated imaging system of claim 1, wherein the controller incrementally adjusts the voltage applied to the first LCPG device and the second LCPG device in a sequential order and wherein the camera captures images at each incremental adjustment in the voltage.

10. The steerable gated imaging system of claim 9, wherein the controller further comprises a processor, wherein the processor combines the images captured.

11. The steerable gated imaging system of claim 1, wherein the controller incrementally adjusts the voltage applied to the first LCPG device and the second LCPG device in a non-sequential order and wherein the camera captures images at each incremental adjustment in the voltage.

12. The steerable gated imaging system of claim 11, wherein the controller further comprises a processor, wherein the processor combines the images captured.

13. A steerable gated imaging system for a vehicle, the vehicle having a controller that controls a voltage applied to the steerable gated imaging system, the steerable gated imaging system comprising:
a light source, wherein the light source emits a pulse of light during a pre-determined time interval towards an object external to the vehicle and wherein the pulse of light creates a reflection of light off of the object;
a camera including a camera sensor, wherein the camera captures an image when the camera sensor senses the reflection of light;
a first liquid crystal polarized grating (LCPG) device, wherein the first LCPG device is adjacent to the light source and wherein the pulse of light is emitted through the first LCPG device;
a second LCPG device, wherein the second LCPG device is adjacent to the camera and wherein the reflection of light travels through the second LCPG device; and
a gate, wherein the gate has a position, the position includes:
a closed position, wherein the closed position prevents the reflection of light from reaching the camera sensor; and
an open position, wherein the open position allows the reflection of light to reach the camera sensor,
wherein the voltage is applied to the first LCPG device to steer the pulse of light towards the object,
wherein the voltage is applied to the second LCPG device to steer the reflection of light towards the camera, and
wherein the voltage is incrementally adjusted in a sequential order.

14. The steerable gated imaging system of claim 13, wherein the steerable gated imaging system further comprises a delay period, wherein the delay period is a period of time after the pulse of light has been emitted, and wherein the gate is in the closed position during the delay period.

15. The steerable gated imaging system of claim 13, wherein the steerable gated imaging system further comprises a time gate, wherein the time gate is a period of time that the gate is in the open position.

16. The steerable gated imaging system of claim 13, wherein the camera further comprises capturing images at each incremental adjustment of the voltage and wherein the images are combined to create a final image.

17. A steerable gated imaging system for a vehicle, the vehicle having a controller that controls a voltage applied to the steerable gated imaging system, the steerable gated imaging system comprising:
a light source, wherein the light source emits a pulse of light during a pre-determined time interval towards an object external to the vehicle and wherein the pulse of light creates a reflection of light off of the object;
a camera including a camera sensor, wherein the camera captures an image when the camera sensor senses the reflection of light;
a first liquid crystal polarized grating (LCPG) device, wherein the first LCPG device is adjacent to the light source and wherein the pulse of light is emitted through the first LCPG device;
a second LCPG device, wherein the second LCPG device is adjacent to the camera and wherein the reflection of light travels through the second LCPG device; and
a gate, wherein the gate has a position, the position includes:
a closed position, wherein the closed position is between the camera and the second LCPG device and wherein the closed position prevents the reflection of light from reaching the camera sensor; and
an open position, wherein the open position allows the reflection of light to reach the camera sensor,
wherein the voltage is applied to the first LCPG device to steer the pulse of light towards the object,
wherein the voltage is applied to the second LCPG device to steer the reflection of light towards the camera, and
wherein the voltage is incrementally adjusted in a non-sequential order.

18. The steerable gated imaging system of claim 17, wherein the steerable gated imaging system further comprises a delay period, wherein the delay period is a period of time after the pulse of light has been emitted and wherein the gate is in the closed position during the delay period.

19. The steerable gated imaging system of claim 17, wherein the steerable gated imaging system further comprises a time gate, wherein the time gate is a period of time that the gate is in the open position.

20. The steerable gated imaging system of claim 17, wherein the camera further comprises capturing images at each incremental adjustment in the voltage and wherein the images are combined to create a final image.
